(19) United States
(12) Patent Application Publication
(10) Pub. No.: US 2021/0324920 A1
(43) Pub. Date: Oct. 21, 2021

(54) Device for quickly adjusting initial engagement characteristics of a clutch

(71) Applicant: Granville M. Robbins, JR., Concrete, WA (US)

(72) Inventor: Granville M. Robbins, JR., Concrete, WA (US)

(21) Appl. No.: 16/873,462

(22) Filed: Apr. 16, 2020

(51) Int. Cl. F16D 25/08; F15B 15/02

(52) U.S. Cl. CPC F16D 25/08; F16D 2025/081; F15B 15/02

(57) ABSTRACT

An easily installed and quick reacting in-line clutch engagement control device for hydraulically actuated power transmission friction clutches. The device allows a simple way to quickly and precisely limit a friction clutch's initial torque capacity to an easily adjustable pre-set level.

### BACKGROUND OF THE INVENTION

Excess torque capacity allows a power transmission clutch to draw additional inertia energy from a drive engine's rotating assembly, which causes the drive engine to lose speed as that inertia energy is transferred from the drive engine's rotating assembly to it's driven components. This energy exiting the rotating assembly adds to the torque being produced by the drive engine, creating a “spike” of higher torque output that is passed along to the driven components. That spike of drive engine torque+inertia torque may exceed the driven component's ultimate capacity if not controlled, which can in-turn result in damage to the driven components. Operators can typically control the intensity of this torque spike manually, a learned process of using his/her feet or hands to modulate both power and clutch torque capacity to achieve smooth operation of the machine/vehicle. When faced with urgency, manual control of engagement intensity can become very inconsistent which can expose components to potential damage. Since the best solution is not always merely one of “beefing up” the individual components, various engagement damping devices have been conceived and are well-known in the art.

### FIELD OF THE INVENTION

The present invention relates to vehicle power application, and more particularly, effective use of clutch engagement dampening as a way of temporarily limiting the application of torque to vehicle transmissions and driveline components. Power transmission friction clutches are typically designed with an excess of torque capacity which is typically required for the clutch to be functionally effective. Excess torque capacity is a necessary part of friction clutch design as it ensures a given clutch will still have adequate torque capacity at the end of it's service life after it's friction surfaces have worn. Excess initial clutch torque capacity has the potential to cause damage to driven components and or cause other negative effects with regards to effective operation of the machine/vehicle. In a drag race type scenario, a clutch with too much torque capacity can easily draw too much inertia from a drive engine's rotating assembly, which in-turn draws down the drive engine's rpm and power output to levels below what is needed to be competitive.

### RELATED ART DISCLOSURE

The prior art of slowing a hydraulically actuated clutch's engagement rate by way of simple in-line hydraulic restriction has been a somewhat effective. Basically hydraulic restriction automatically reduces the peak intensity of an inertia induced torque spike by spreading it over a longer time period, thus removing some aspect of manual skill and human variable. The downside to slowing hydraulically actuated clutch engagement by way of simple in-line hydraulic restriction can be that the restriction also delays the time it takes for a clutch to go from a fully released position to an effective level of partial clutch engagement. This partial engagement delay can have a negative effect of increased reaction times of the system, as well as result in the clutch's friction surfaces wearing at a faster rate. Negative effects may also include increased roll-back due to the delay if for instance one is attempting to start a vehicle in motion while sitting on an upward incline. Another negative effect of simple hydraulic restriction may include increased reaction time due to the restriction when reacting to a start signal while participating in a timed motor vehicle competition such as a drag race.

Another drawback to simple hydraulic restriction placed between the system's “master cylinder” and it's “slave cylinder” is that the restriction can cause the “master cylinder” return spring to draw fluid past a cup style seal during the “master cylinder” return stroke. This happens when the “master cylinder” internal return spring returns it's piston at a faster rate than than the restriction allows, which causes an excessive amount of make-up fluid to be drawn from the “master cylinder” fluid reservoir. This can cause a “pump-up” effect when the “master cylinder” is actuated in quick succession, as excess fluid does not have enough time to return to the reservoir before the next actuation cycle. This “pump-up” effect leads to an excessive level of clutch dis-engagement, which in-turn leads to excessive level of clutch slippage after a clutch assisted shift.

### EXAMPLES OF PRIOR ART

clutchmasters.com/content/FCV2000diagram.pdf

magnusmotorsports.com/product/magnus-launch-control-device/tiltonracing.com/wp-content/uploads/2013/07/98-1280-Flow-Control-Valve.pdf

maperformance.com/products/map-hydraulic-launch-control-device-for-manual-transmission-vehicles

geneberg.com/cat.php?cPath=18_2829

U.S. Pat. No. 5,213,187

U.S. Pat. No. 8,522,942 B2

US Patent Number: US 2007/0175727 A1

U.S. Pat. No. 3,963,107

### SUMMARY OF THE INVENTION

The invention is a control valve system that is easily adaptable to a wide variety of vehicles or machines that use hydraulically actuated clutch release systems.

The valve system can effectively remove much of the inconsistent human element from manually controlling the intensity of a friction clutch's initial engagement phase.

The invention effectively creates a quick, tuneable, temporary, and consistent initial level of partial clutch engagement that smoothes engagement quality, without reducing the clutch's overall ultimate torque capacity.

The need for reduced clutch torque capacity may or may not be temporary.

The invention may or may not be used in conjunction with an internal or external bleed orifice or timed bypass circuit.

A timed bypass solenoid circuit may be added to render the invention's initial reduced clutch torque capacity effect as a short term timed event.

A timed bypass circuit effectively can give “make-up” fluid far more time to return to the “master cylinder” reservoir than a simple return fluid restriction. This in-turn reduces or eliminates any “pump-up” effect. from actuating the “master cylinder” in quick successive cycles.

It is understood that while the forms of the invention herein shown and described constitute the preferred embodiments of the invention, they are not intended to illustrate all possible forms thereof. Also understood is that the words used are words of description rather than limitation, and that various changes may be made without departing from the spirit and scope of the invention as recited by the following claims.

### DESCRIPTION OF DRAWINGS

FIG. 1A is a cross section view of the invention's internal state when at rest, also the invention's PISTON 10 internal reaction to initial fluid flow into the invention through FLUID PORT 20.

FIG. 2A is a cross section view showing the invention's internal reaction to return fluid flow entering FLUID PORT 21.

FIG. 3A has arrows showing how ADJUSTABLE STOP ROD 9 can be threaded in/out of ADJUSTABLE REFERENCE HOUSING 8 to change the effective travel distance of PISTON 10.

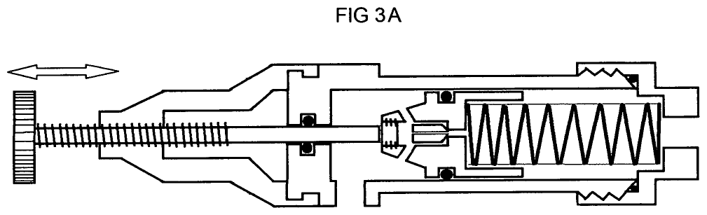

FIG. 3B has arrows showing fluid flow directions when pressure is applied to the system's “master cylinder”.

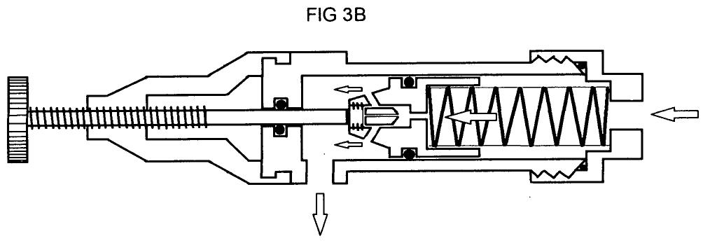

FIG. 3C has arrows showing fluid flow direction at the mid-point of PISTON 10 travel.

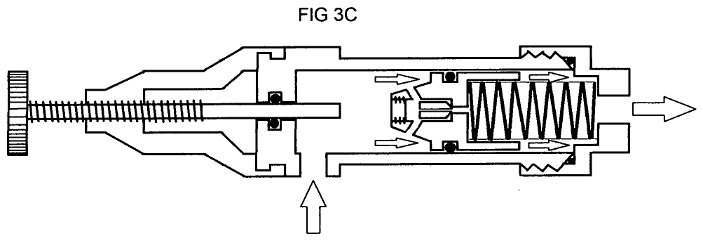

FIG. 3D has arrows showing remaining fluid flow thru METERING ORIFICE 23 after PISTON 10 comes contact with HOUSING CAP 7.

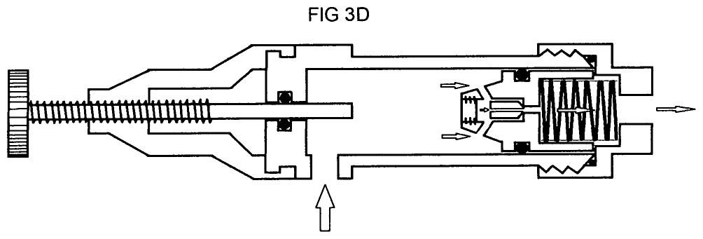

### DESCRIPTION OF INVENTION

The preferred embodiment of the invention is a suitable cylinderically shaped outer housing assembly containing a spring biased internal piston/valve assembly with an externally adjustable piston travel limiting stop. Ideally it would be plumbed hydraulically in-line between a power transmission clutch's “master cylinder” and it's “slave cylinder” or “hydraulic throwout bearing”.

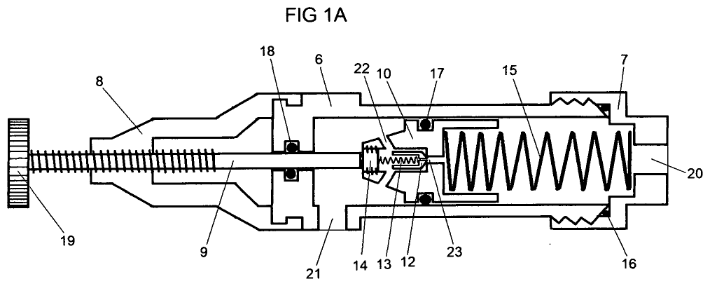

FIG. 1A represents the invention's at rest internal orientation with BIAS SPRING 15 pushing PISTON 10 against ADJUSTABLE STOP ROD 9.

ADJUSTABLE STOP ROD 9 is threaded into ADJUSTMENT REFERENCE HOUSING 8, allowing for an external adjustment of overall PISTON 10 travel distance within HOUSING BODY 6.

When fluid flows from the clutch release system's “master cylinder” into the invention through FLUID PORT 20, that fluid cannot move PISTON 10 because BIAS SPRING 15 is already holding PISTON 10 against ADJUSTABLE STOP ROD 9.

The building pressure of fluid entering FLUID PORT 20 then pushes CHECK VALVE 12 off it's seat, allowing fluid to bypass thru the center of PISTON 10 unrestricted. Fluid then exits the invention through FLUID PORT 21 on it's way to actuate the system's “slave cylinder”.

As an alternate fluid path, an external valve(s) can be plumbed in parallel to FLUID PORT 20 and FLUID PORT 21 as an effective substitute for the functions of CHECK VALVE 12 and CHECK VALVE SPRING 13.

When actuating pressure is relieved at the FLUID PORTY 20 “master cylinder” end of the system, fluid flow direction reverses, causing fluid to return into the invention through FLUID PORT 21.

The resulting pressure difference causes the fluid flow into FLUID PORT 21 to quickly seal CHECK VALVE 12 against it's seat, causing pressure to build which then moves PISTON 10 within HOUSING BODY 6, causing PISTON 10 to in-turn compress BIAS SPRING 15.

The moving PISTON 10 pushes fluid on it's opposite side to exit the invention through FLUID PORT 20, allowing fluid to return unrestricted on it's path back to the system “master cylinder”.

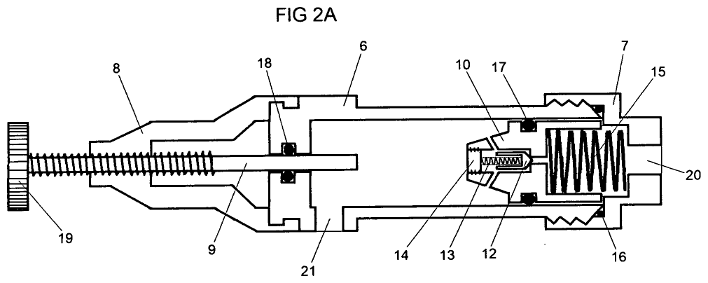

When a sufficient volume of has fluid entered FLUID PORT 21 to move PISTON 10 to the point that it contacts HOUSING CAP 7 as illustrated by FIG. 2A.

After the point where PISTON 10 reaches it's limit of travel distance by contacting HOUSING CAP 7, the balance of “slave cylinder” return fluid volume flowing back into FLUID PORT 21 of the invention then becomes controlled by the flow rate through METERING ORIFICE 23.

METERING ORIFICE 23 further functions to allow the fluid flow necessary to facilitate BIAS SPRING 15 function of returning PISTON 10 to it's at rest position against ADJUSTABLE STOP ROD 9.

An alternate to METERING ORIFICE 23 is a solenoid valve hydraulically plumbed parallel to the invention's FLUID PORT 20 and FLUID PORT 21. This alternate return flow arrangement facilitates a very rapid return of PISTON 10 to it's at rest position against ADJUSTABLE STOP ROD 9.

Having described my invention, I claim:

1. A device that allows an adjustable partial volume of hydraulic fluid to return un-restricted from a clutch slave cylinder back to the clutch master cylinder during a clutch's engagement cycle, with the precise volume of un-restricted return flow determined by adjusting the stroke distance of a piston acting within a suitable hydraulic cylinder assembly, thus allowing quick partial engagement of the clutch up to the point that the piston reaches the limit of it's travel, which creates a near instant but temporary 1st stage level of reduced torque capacity that effectively reduces the inertia induced torque spike that would normally result from sudden clutch engagement, with the device acting in conjunction with an internal or external valve arrangement that controls fluid movement after the piston reaches the limit of it's travel during the clutch engagement cycle, allowing a secondary controlled flow of fluid returning to the master cylinder that allows the clutch to reach a 2nd stage of full clutch torque capacity while also allowing the fluid flow necessary for the devices' internal piston to return to it's at-rest spring biased position, while an internal or external check valve arrangement allows fluid to flow past the piston without restriction while dis-engaging the clutch.
